(19) United States
(12) Patent Application Publication
(10) Pub. No.: US 2007/0253655 A1
(43) Pub. Date: Nov. 1, 2007

(54) Rolling bearing

(75) Inventors: Masaki Egami, Kuwana-shi (JP); Mitsunari Asao, Kuwana-shi (JP); Tomoaki Goto, Shizuoka (JP)

Correspondence Address: HEDMAN & COSTIGAN P.C., 1185 AVENUE OF THE AMERICAS, NEW YORK, NY, 10036, US

(73) Assignee: NTN CORPORATION, Osaka (JP)

(21) Appl. No.: 11/821,386

(22) Filed: Jun. 22, 2007

Related U.S. Application Data
(63) Continuation-in-part of application No. PCT/JP05/23910, filed on Dec. 27, 2005.

(30) Foreign Application Priority Data
Dec. 28, 2004 (JP) 2004-379102
Dec. 28, 2004 (JP) 2004-379103
Jan. 18, 2005 (JP) 2005-010908
Feb. 21, 2005 (JP) 2005-044562

(51) Int. Cl. F16C 33/76

(52) U.S. Cl. 384/484

(57) ABSTRACT

The present invention provides a reliable and durable rolling bearing incorporated in various industrial machines, vehicles, and the like, having a sealing member which deteriorates to a low extent and maintains preferable sealing performance for a long time. The rolling bearing includes an inner ring; an outer ring; a plurality of rolling elements interposed between the inner ring and the outer ring; and the sealing member provided at an open portion which is disposed at both axial ends of the inner ring and the outer ring. The sealing member comprises a rubber molding that contacts at least water, an alkali solution, grease, or the like. The rubber molding is made of a vulcanizable fluororubber composition which comprises a copolymer containing tetrafluoroethylene; propylene; and a crosslinkable monomer which is an unsaturated hydrocarbon having two to four carbon atoms, in which a part of hydrogen atoms is substituted with fluorine atoms.

### TECHNICAL FIELD

The present invention relates to a rolling bearing incorporated in various industrial machines, vehicles, and the like, and particularly, to a rolling bearing in which a sealing member is composed of a molding made of a vulcanizable fluororubber composition.

### BACKGROUND ART

In chemical plant equipment such as a plant for producing a macromolecular material, an apparatus for producing liquid crystal films, and the like, a treating bath is present in an alkali high-concentration solution. A rolling bearing used for stirring and transport has a problem that it has a comparatively short life. Generally, stainless steel and ceramic highly resistant to corrosion are used for an inner ring, an outer ring, and a rolling element of such a bearing. The cause of the short life of the bearing includes wear and locking owing to penetration of a hard foreign matter thereinto from outside. To prevent the penetration of the hard foreign matter thereinto, it is preferable to provide a sealing member at an open portion which is disposed at both axial ends of the inner ring and the outer ring. Generally when acrylonitrile rubber or acrylic rubber which has been hitherto used is used as the sealing member, the rubber materials are low in alkali resistance thereof. Therefore the rubber materials melt and deteriorate in the strength thereof to a high extent and are broken and thus durability thereof cannot be secured. On the other hand, fluororubber is excellent in its chemical resistance. As the fluororubber conventionally used, so-called FKM such as a bipolymer (VDF-HFP) of vinylidene fluoride and hexafluoropropylene and a terpolymer (VDF-HFP-TFE) formed by adding tetrafluoroethylene to the bipolymer (VDF-HFP) are known. But when these fluororubbers have high alkali concentration, they become low in the strength thereof and are incapable of obtaining a sufficient durability.

To solve the above-described problem, a method of improving the durability of the rolling bearing in an alkali solution by using an alkali-resistant resin material such as polyethylene as the material of the sealing member is known (see patent document 1).

But when the sealing member and a sliding-contact portion of the inner ring or that of the outer ring are brought into contact with each other to improve the sealing performance, there occurs a problem that the tensile force of the contact portion becomes high because the resin has a high elastic modulus and the rotation torque of the bearing becomes large. A method of adopting a noncontact-type seal to prevent an increase of the torque is also known. But this method prevents the penetration of the foreign matter incompletely, thus causing the rolling bearing to have a short life.

Even though the above-described fluororubber is used, it is difficult to prevent the fluororubber from deteriorating with time.

When a rubber elastomer used for the sealing member is hardened owing to deterioration with time, the sealing performance thereof deteriorates. Further a contact pressure on a sealing surface becomes high, and the rotation torque of the bearing becomes high. Thereby frictional heat generation occurs, and the deterioration of the sealing member proceeds further.

At a cutting step and a grinding step of a to-be-processed material which are important steps in manufacturing mechanical products by processing a metal material, a cutting lubricant or a grinding lubricant (hereinafter abbreviated as “cutting lubricant”) is used to maintain lubricating property between a tool and the to-be-processed material, cool a surface to be processed, and clean generated chips. As the cutting lubricant, an on aqueous cutting lubricant has been used much. But the cutting lubricant is flammable owing to frictional heat generated by friction between the to-be-processed material and the tool rotating at a high speed, and the nonaqueous cutting lubricant causes high environmental load at a discard time. Thus in recent years, a water-soluble cutting lubricant is increasingly used. The water-soluble cutting lubricant is apt to be rotten when the pH thereof is not more than eight. Thus the water-soluble cutting lubricant contains a large amount of an amine compound such as alkanolamine to keep the pH more than eight and to prevent it from being rotten. The cutting lubricant contacts bearings for supporting a main spindle of a machine tool and a ball screw. The bearing is provided with a seal to prevent penetration of dust from outside and leak of lubricating grease enclosed inside the bearing.

A method of preventing deformation of the seal by adopting a vulcanizable fluororubber composition containing a vinylidene fluoride-tetrafluoroethylene-propylene terpolymer or a vulcanizable fluororubber composition containing a tetrafluoroethylene-propylene bipolymer as a material for use in the sealing member of the bearing for use in the machine tool is known (see patent document 2).

Even though the above-described fluororubber composition is used, however, the sealing performance of the sealing member may deteriorate with time owing to contact between the sealing member and the cutting/grinding lubricant. Thus it cannot be said that the performance of the sealing member is sufficient.

Owing to the spread of an FF (front engine and front drive) car intended to manufacture a compact and lightweight car and owing to an increase of a living space in the car, the space of the engine room of the car cannot but be decreased. Therefore reduction in size and weight of auxiliaries for use in cars is increasingly pursued, and development of auxiliaries having high performance and output is increasingly demanded.

The operating temperature condition for the rolling bearing for use in a cooling-water pump which is an auxiliary apparatus for use in the car has become strict. There is a case in which the bearing is exposed to a temperature exceeding 120° C. A method of preventing deformation of the sealing member by adopting a vulcanizable fluororubber composition containing the above-described vinylidene fluoride-tetrafluoroethylene-propylene terpolymer or a vulcanizable fluororubber composition containing a tetrafluoroethylene-propylene bipolymer as a material for a rubber molding of a seal unit of the rolling bearing for use in the cooling-water pump is known (see patent document 3).

Even though the above-described fluororubber composition is used, however, there is a possibility that the sealing member deteriorates with time owing to contact between the sealing member and the coolant in the cooling water and lowers its sealing performance. Thus it cannot be said that the performance of the sealing member is sufficient.

In recent years, a fuel cell system has attracted public attention as a new power source or a distributed generating set for a car. A fuel cell has a high output density, and operates at a low temperature, and a cell-constructing material thereof deteriorates little. Of fuel cells, a solid macromolecular electrolyte-type fuel cell which starts easily is regarded as effective as power sources of transportation such as the car.

In the fuel cell system, it is necessary to feed hydrogen or hydrogen-rich reformed gas as the fuel and air as an oxidizing agent under pressure to the fuel cell. Various compressed fluid-feeding machines such as a super-charger, an impeller-type compressed fluid-feeding machine, a scroll-type compressed fluid-feeding machine, a swash plate-type compressed fluid-feeding machine, and a screw-type compressed fluid-feeding machine are used.

In the solid macromolecular electrolyte-type fuel cell, water is generated in a chemical reaction for electric power generation, and to allow a macromolecular film of the fluororesin to function as a solid electrolyte, it is humidified by a humidifier so that the macromolecular film is always maintained in a moisture-containing state. Thus moisture is contained in the gas fed under pressure by the compressed fluid-feeding machine. Further in the fuel cell system, because hydrogen fuel is circulated to recycle it, acidic substance liberates from the electrolyte.

Because the rolling bearing incorporated in the compressed fluid-feeding machine contacts the moisture and the acidic substance as described above, the rolling bearing for use in the fuel cell system is demanded to have an excellent rust preventative properties.

In correspondence with a demand for an increase of a power generation quantity, the compressed fluid-feeding machine is demanded to have higher speed and performance. Because the rolling bearing rotates at a high speed and under a high load, it may occur that a bearing part has a high temperature of about 180° C. Thus the rolling bearing is demanded to be excellent in heat resistance.

When hydrogen or hydrogen-rich reformed gas used as fuel penetrates into the rolling bearing, metal flaking occurs on the rolling surface of the bearing owing to the brittleness of hydrogen. Therefore the rolling bearing is demanded to have sealing performance of preventing the rolling surface of the bearing from contacting hydrogen.

Because the compressed fluid-feeding machine is demanded to reliably operate for a long time, the rolling bearing is also demanded to have a long life.

For these reasons, as a material for a rubber molding of a seal unit of the rolling bearing for use in a compressed fluid-feeding machine for feeding under pressure a fluid used in a fuel cell system, a method of preventing deformation of the sealing member by adopting the above-described vulcanizable fluororubber composition containing the vinylidene fluoride-tetrafluoroethylene-propylene terpolymer or the vulcanizable fluororubber composition containing the tetrafluoroethylene-propylene bipolymer is known (see patent document 4).

Even though the above-described fluororubber is used, however, under high-temperature and high-speed condition in which the rolling bearing for use in the fuel cell system is demanded to operate, it is difficult to prevent the fluororubber from deteriorating with time.

The urea-based grease is hitherto mainly used to lubricate the rolling bearing incorporated in the above-described various industrial machines, vehicles, and the like. When a temperature condition is stricter, the fluorine grease is used. In the combination of the fluororubber and the urea-based grease, there is a case in which owing to a urea compound, crosslinking of the fluororubber proceeds and hardens. Because the fluorine grease is very expensive or because a rust-preventive agent which can be added to the urea-based grease is limited, mixed grease of the fluorine grease and grease other than the fluorine grease (see patent document 5) and the urea-based grease (see patent document 4) are also used.

Patent document 1: Japanese Patent Application Laid-Open No. 2003-49855

Patent document 2: Japanese Patent Application Laid-Open No. 2002-310171

Patent document 3: Japanese Patent Application Laid-Open No. 2002-181056

Patent document 4: Japanese Patent Application Laid-Open No. 2001-65578

Patent document 5: Japanese Patent Application Laid-Open No. 2003-239997

### DISCLOSURE OF THE INVENTION

### Problems to be Solved by the Invention

The present invention has been made to solve the above-described problems. Therefore it is an object of the present invention to provide a reliable and durable rolling bearing incorporated in various industrial machines, vehicles, and the like, having a sealing member which deteriorates to a low extent and maintains preferable sealing performance for a long time.

### MEANS FOR SOLVING THE PROBLEMS

The rolling bearing of the present invention includes an inner ring; an outer ring; a plurality of rolling elements interposed between the inner ring and the outer ring; and a sealing member provided at an open portion which is disposed at both axial ends of the inner ring and the outer ring. The sealing member has a rubber molding. The rubber molding is made of a vulcanizable fluororubber composition which comprises a copolymer containing tetrafluoroethylene; propylene; and a crosslinkable monomer which is an unsaturated hydrocarbon having two to four carbon atoms, in which a part of hydrogen atoms is substituted with fluorine atoms.

The crosslinkable monomer is at least one monomer selected from among trifluoroethylene; 3,3,3-trifluoropropene-1; 1,2,3,3,3-pentafluoropropene; 1,1,3,3,3-pentafluoropropylene; and 2,3,3,3-tetrafluoropropene.

The copolymer contains vinylidene fluoride.

A rubber hardness of the molding of the fluororubber composition is 60° to 90°. The rubber hardness (degree) is measured in accordance with JIS K 6253.

The rolling bearing can be used as a rolling bearing for an alkali environment, which is used in an alkali atmosphere. In this case, the sealing member is characterized in that it has a rubber molding that contacts at least the alkali atmosphere. The alkali atmosphere means a state in which the rolling bearing contacts an alkali gas, an alkali solution, and an alkali solid steadily or unsteadily. The inner ring of the rolling bearing, the outer ring thereof, and the rolling elements thereof are made of corrosion-resistant steel or ceramic.

The rolling bearing can be used for a machine tool for cutting or grinding a material to be processed with a cutting lubricant or a grinding lubricant being interposed between the material to be processed and machine tool. In this case, the sealing member has the rubber molding which contacts at least the above-described cutting lubricant or the above-described grinding lubricant.

The above-described rolling bearing for use in the machine tool is a main spindle bearing or a ball screw support bearing.

The rolling bearing can be used as a rolling bearing for a cooling-water pump. In this case, a rotation shaft is supported by the inner ring, with one end of the rotation shaft connected to a pulley driven by an engine and other end of the rotation shaft connected to an impeller for circulating cooling water; the outer ring is fixed to a housing; a plurality of rolling elements is interposed between the inner ring and the outer ring; a space between the rotation shaft and the outer ring is sealed by a pair of sealing members, having a rubber molding respectively, which is fixed to both ends of the outer ring; and the molding of the fluororubber composition is used for a rubber molding of the sealing member disposed at least at a side of the impeller.

The rolling bearing can be used as a rolling bearing for a fuel cell system to rotatably support a rotational portion provided on a compressed fluid-feeding machine for feeding a fluid which is used in the fuel cell system. In this case, the rolling bearing has the inner ring; the outer ring; a plurality of the rolling elements interposed between the inner ring and the outer ring; an urea compound-containing grease which is enclosed on the periphery of the rolling elements; and the sealing member for sealing the above-described grease, which is provided at the open portion disposed at both axial ends of the inner ring and the outer ring. The sealing member has the rubber molding that contacts at least the above-described grease. The rubber molding consists of the fluororubber composition of the rolling bearing.

The grease containing the urea compound is mixed grease of fluorine grease and urea grease.

### EFFECT OF THE INVENTION

In the rolling bearing of the present invention, the sealing member is formed of the molding of the vulcanizable fluororubber composition which comprises the copolymer containing the tetrafluoroethylene; the propylene; and the crosslinkable monomer which is the unsaturated hydrocarbon having two to four carbon atoms, in which a part of hydrogen atoms is substituted with fluorine atoms. Thus for example, even though the sealing member is dipped in water, an alkali solution, or grease, the sealing member deforms to a low extent and deteriorates to a low extent in its properties. Further the sealing member is capable of effectively preventing the penetration of a foreign matter from the outside and the leak of the grease. Therefore even when the rolling bearing is used, for example, in the alkali atmosphere, at a high temperature not less than 180° C., or at a high rotational speed not less than 10000 rpm, the rolling bearing is allowed to have a high durability.

### BEST MODE FOR CARRYING OUT THE INVENTION

As a result of the present inventors' energetic investigations to provide a reliable and durable rolling bearing having a sealing member which deteriorates to a low extent and maintains preferable sealing performance, they have found that the sealing member produced from a molding of a vulcanizable fluororubber composition which comprises a copolymer containing tetrafluoroethylene; propylene; and a crosslinkable monomer which is an unsaturated hydrocarbon having two to four carbon atoms, in which a part of hydrogen atoms is substituted with fluorine atoms (hereinafter abbreviated as fluororubber molding) deteriorates to a low extent, even though it contacts water, an alkali solution, grease, or the like, and in addition is capable of effectively preventing dust from penetrating into the rolling bearing from the outside. The present invention is based on such finding.

The fluororubber composition that can be used in the present invention is a vulcanizable fluororubber composition which comprises a copolymer containing tetrafluoroethylene; propylene; and a crosslinkable monomer which is an unsaturated hydrocarbon having two to four carbon atoms, in which a part of hydrogen atoms is substituted with fluorine atoms.

As the crosslinkable monomer which consists of unsaturated hydrocarbon having two to four carbon atoms, in which a part of hydrogen atoms is substituted with fluorine atoms, trifluoroethylene; 3,3,3-trifluoropropene-1; 1,2,3,3,3-pentafluoropropene; 1,1,3,3,3-pentafluoropropylene; and 2,3,3,3-tetrafluoropropene are listed. Of the above-described crosslinkable monomers, the 3,3,3-trifluoropropene-1 is preferable.

Vinylidene fluoride, chlorotrifluoroethylene, perfluoro(alkylvinyl)ether, perfluoro (alkoxyvinyl)ether, perfluoro(alkoxyalkylvinyl)ether, perfluoroalkylalkenyl ether, perfluoroalkoxyalkenyl ether, and the like can be added to the copolymer of the present invention as the fourth component thereof.

For the entire copolymer composing the fluororubber composition, the mixing amount of the tetrafluoroethylene is 45 to 80 wt %, favorably 50 to 78 wt %, and more favorably 65 to 78 wt %; the mixing amount of the propylene is 10 to 40 wt %, favorably 12 to 30 wt %, and more favorably 15 to 25 wt %; and the mixing amount of the crosslinkable monomer is 0.1 to 15 wt %, favorably 2 to 10 wt %, and more favorably 3 to 6 wt %.

When the vinylidene fluoride is copolymerized, the mixing amount of the vinylidene fluoride is 2 to 20 wt % and favorably 10 to 20 wt %. At more than 20 wt % in the mixing amount of the vinylidene fluoride, the resistance of the copolymer to an alkali compound deteriorates when the copolymer is used in the alkali atmosphere, the resistance of the copolymer to a cutting lubricant or a grinding lubricant deteriorates when the copolymer contacts the cutting lubricant or the grinding lubricant, the resistance of the copolymer to a coolant in cooling water of an engine deteriorates when the copolymer contacts the coolant, and the resistance of the copolymer to an urea compound deteriorates when the copolymer is used together with the urea compound.

The method of producing the fluororubber is disclosed in international publication No. WO02/092683. The fluororubber is produced by emulsion polymerization or suspension polymerization.

To allow the fluororubber to be vulcanizable, it is possible to add thereto a polyhydroxy (polyol) vulcanizing agent; a vulcanization accelerator selected from among quaternary ammonium salts, quaternary phosphonium salts, tertiary sulfonium salts, and the like; an acid-accepting agent such as calcium hydroxide, magnesium oxide, and the like; a filler such as carbon black, clay, barium sulfate, calcium carbonate, magnesium silicate, and the like; a processing aid such as octadecyl amine, wax, and the like; a thermal aging inhibitor; and a pigment. Regarding the mixing amount of each agent, for 100 parts by weight of the copolymer, the vulcanizing agent is 0.1 to 20 parts by weight and favorably 0.5 to 3 parts by weight; the vulcanization accelerator is 0.1 to 20 parts by weight and favorably 0.5 to 3 parts by weight; the acid-accepting agent is 1 to 30 parts by weight and favorably 1 to 7 parts by weight; the filler is 5 to 100 parts by weight; and the processing aid is 0.1 to 20 parts by weight.

In addition to these agents, it is possible to use 0.7 to seven parts by weight and favorably one to three parts by weight of a second vulcanizing agent such as an organic peroxide compound. In addition, fillers and additives to be contained in known rubber compositions can be appropriately used within a range in which they do not damage the resistance of the copolymer to the urea compound and the sealing performance thereof.

A process used in common rubber processing can be adopted as a method of mixing the above-described components with one an other or molding the rubber composition. After the components are kneaded by an open roll, a Banbury mixer, a kneader, an enclosed-type mixer of various kinds, or the like, the rubber composition is press-molded (press-vulcanized), extrusion-molded or injection-molded. To improve the property of the rubber composition, after the rubber composition is molded, it is preferable to secondarily vulcanize the rubber composition by sufficiently heating (for example, 200° C., 24 hours) it in an oven.

The rubber hardness of the molding of the fluororubber composition which can be used in the present invention is 60° to 90° and favorably 70° to 80°. If the rubber hardness is less than 60°, the obtained molding is so soft that the wear resistance thereof deteriorates. If the rubber hardness is more than 90°, the rotation torque of the rolling bearing is so large that the temperature thereof rises. The rubber hardness (degree) is measured in accordance with JIS K 6253.

The sealing member may consist of the rubber molding alone or a composite of the rubber molding and a metal plate, the rubber molding and a plastic plate, and the rubber molding and a ceramic plate, and the like. The composite of the rubber molding and the metal plate is preferable because the composite of the rubber molding and the metal plate is durable and the rubber molding and the metal plate easily adhere to each other.

FIG. 2 shows an example of the sealing member 6 consisting of the composite of the rubber molding and the metal plate. FIG. 2 is a sectional view of the sealing member of the rolling bearing. The sealing member 6 is obtained by fixing a fluororubber molding 6b to a metal plate 6a such as a steel plate. Both a mechanical fixing method and a chemical fixing method can be used. It is preferable to adopt a fixing method in which molding and vulcanization are performed at the same time when the fluororubber molding is vulcanized, with the metal plate disposed in a vulcanizing can.

As shown in FIGS. 1 and 2, as methods of mounting the sealing member 6 on the rolling bearing: (1) One end 6f of the sealing member 6 is fixed to the outer ring 3, whereas an auxiliary lip portion 6d of the sealing member 6 is disposed along a V-groove of a sealing surface of the inner ring 2 to form a labyrinth gap. (2) The one end 6f of the sealing member 6 is fixed to the outer ring 3, whereas the auxiliary lip portion 6d thereof is brought into contact with a side surface of the V-groove of the sealing surface of the inner ring 2. (3) The one end 6f of the sealing member 6 is fixed to the outer ring 3, whereas the auxiliary lip portion 6d thereof to be brought into contact with the side surface of the V-groove of the sealing surface of the inner ring 2 is provided with a slit for preventing suction of the auxiliary lip portion 6d to form a low torque construction.

In any of the above-described mounting methods, a solution on the periphery of the sealing member 6 contacts a rubber molding 6b composing the sealing member 6. A portion of the rubber molding 6b that contacts water, an alkali solution, or enclosed grease is made of the above-described fluororubber molding. For example, the rubber molding 6b may consist of the above-described fluororubber molding alone. Alternatively the rubber molding 6b may be composed as a laminate of the above-described fluororubber molding disposed at the portion that contacts water, an alkali solution, the grease, or the like and the conventional rubber molding disposed on the rear surface of the fluororubber molding.

FIG. 1 shows an example of the rolling bearing of the present invention. FIG. 1 is a sectional view of the rolling bearing.

The rolling bearing 1 includes an inner ring 2 having an inner ring rolling surface 2a on its outer peripheral surface, an outer ring 3 having an outer ring rolling surface 3a on its inner peripheral surface, with the outer ring 3 concentric with the inner ring 2, and a plurality of rolling elements 4 interposed between the inner ring rolling surface 2a and the outer ring rolling surface 3a. Sealing members 6 fixed to the outer ring 3 are provided at openings 8a and 8b of the inner ring 2 and the outer ring 3 disposed at both axial ends thereof. When the rolling bearing is used for a machine tool, a grease 7 is applied to at least the periphery of each rolling element 4. As the rolling bearing, in addition to a deep groove ball bearing, it is possible to use a seal-type single row angular contact ball bearing which can be applied higher axial load and a sealing-type double row angular contact ball bearing which can be made compact, has a small angular deflection (angular gap), and can be assembled with a high workability.

A working environment in which the rolling bearing of the present invention is used as the rolling bearing for use in an alkali environment or as the rolling bearing for use in a machine tool is the environment in which the rolling bearing substance steadily or unsteadily contacts at least one alkali substance selected from among an alkali gas, an alkali solution, and an alkali solid or steadily or unsteadily contacts cutting oil or grinding oil containing the alkali substance. Of these alkali environments, the rolling bearing of the present invention used as the rolling bearing for use in the alkali environment or as the rolling bearing for use in the machine tool can be especially preferably used in an environment in which the rolling bearing contacts water solutions, ordinarily used, which contains the alkali substance such as sodium hydroxide, potassium hydroxide, and the like in chemical plant equipment such as a plant for producing macromolecular materials, an apparatus for producing liquid crystal films, and the like.

FIG. 3 shows an example of a compressed fluid-feeding machine in which the rolling bearing of the present invention for use in a fuel cell system is used. FIG. 3 is a sectional view of an impeller-type compressed fluid-feeding machine. Arrows shown with one-dot chain line in FIG. 3 indicate a direction in which a gas flows. As shown in FIG. 3, the impeller-type compressed fluid-feeding machine is so constructed that a rotation shaft 10 to which an impeller 9 is fixed is supported on a casing 11 by means of a plurality of rolling bearings 1 axially disposed at certain intervals. When the rotation shaft 10 rotates at a high speed upon receipt of a power of a motor or the like, the impeller 9 also rotates at a high speed. Thereby a gas sucked from a gas-sucking port 12 is pressurized by a centrifugal force of the impeller 9 and fed under pressure from a gas-discharging port 15 through a pressure volute 14 formed with the casing 11 and a back plate 13.

To prevent the gas from leaking from the pressure volute 14 to the rolling bearing 1, the back plate 13 and the rotation shaft 10 are sealed with the seal ring 17 interposed therebetween. But in the impeller-type compressed fluid-feeding machine, when the sealing performance of the seal ring 17 deteriorates owing to a high-speed rotation of the rotation shaft 10, the gas reaches the rolling bearing 1 from a rear space 16 disposed rearward from the impeller 9 through a gap 18 between the rotation shaft 10 and the seal ring 17. To prevent the occurrence of this phenomenon, a mechanical seal 19 is provided. Regarding the sealing performance of the mechanical seal 19, a sliding-contact surface between the mechanical seal 19 and the rotation shaft 10 is lubricated with vapor contained in the gas. Thus as it stands, the vapor or the like leaks and penetrates into the bearing 1. As a result of the penetration of the vapor or the like into the bearing 1, there is a fear that the bearing 1 deteriorates.

Therefore in the rolling bearing of the present invention, to prevent the penetration of the vapor from the impeller 9 into the bearing 1 and to prevent the leak of the grease 7 (see FIG. 1) enclosed inside the bearing 1, the bearing 1 is provided with the sealing member 6 (see FIGS. 1 and 2).

A coolant commercially available contains 90 to 95 wt % of ethylene glycol serving as an antifreeze for preventing freezing thereof in winter; four to six wt % of a rust-preventive agent such as a potassium phosphate salt, an inorganic potassium salt, an organic amine substance, and the like for preventing an engine and a radiator from rusting; and 0 to 5 wt % of water. In cooling water for use in the engine, the dilution amount of the coolant is adjusted in dependence on a antifreeze temperature. For rust-preventing purpose, the dilution amount of the coolant is so adjusted that the concentration of the rust-preventive agent in the cooling water is not less than one wt %.

It is considered that owing to the potassium phosphate salt, the inorganic potassium salt, the organic amine substance, or the like which are an alkali components of the rust-preventive agent added to the cooling water, a sealing member composed of an ordinary fluororubber composition other than the fluororubber composition of the present invention deforms owing to deterioration thereof caused by contact between the sealing member and cooling water, and deteriorates its sealing performance.

An example of a cooling-water pump 24 using the rolling bearing of the present invention for use in the cooling-water pump is described below with reference to FIG. 4. FIG. 4 is a sectional view of the impeller-type compressed fluid-feeding machine in which the rolling bearing of the present invention for use in the cooling-water pump is used. Arrows shown with one-dot chain line in FIG. 4 indicate a direction in which cooling water flows. As shown in FIG. 4, the impeller-type compressed fluid-feeding machine is so constructed that a rotation shaft 10 to which an impeller 9 is connected is fixed to a housing 20 by means of a plurality of rolling bearings 1 axially disposed at certain intervals. The rolling bearing 1 is sealed with a mechanical seal 19 disposed between the impeller 9 and the rolling bearing 1 so that the rolling bearing 1 is prevented from directly contacting the cooling water. But in the rolling bearing 1 for use in the cooling-water pump (hereinafter sometimes referred to as “bearing 1”), a sliding-contact surface between the mechanical seal 19 and the rotation shaft 10 is lubricated with the cooling water. Thus a problem arises that vapor or the like in the cooling water penetrates into the bearing 1 and thus the bearing 1 deteriorates. Therefore a seal unit is provided at the side of the impeller 9 of the bearing 1 to prevent the vapor or the like from penetrating from the impeller 9 into the bearing 1 and to prevent a lubricating grease composition from leaking from the bearing 1 to the impeller 9. The seal unit is also provided at the side of a driving pulley 21 of the bearing 1 to prevent penetration of dust from the outside and to prevent leak of the lubricating grease composition from the bearing 1 to the outside.

The seal unit at the side of the impeller 9 has a construction shown in FIG. 5 as an axial sectional view. FIG. 5 is a partially enlarged sectional view of FIG. 4 and shows the seal unit of the rolling bearing of the present invention for use in the cooling-water pump. Arrows shown with one-dot chain line in FIG. 5 indicate a direction in which the cooling water flows. In FIG. 5, a bearing 1 is constructed of a rotation shaft 10 forming an inner ring 2, an outer ring 3, a plurality of rolling elements 4 interposed between the outer ring 3 and the rotation shaft 10, and a cage 5 retaining the rolling elements 4. A seal unit 23 is constructed of a sealing member 6 and a flinger 22. A sealing member 6 is disposed in a seal groove 3b disposed at an end of the outer ring 3 in an axial direction thereof. The sealing member 6 is constructed of a metal plate 6a and a rubber molding 6b. The rubber molding 6b has three lip portions 6c, 6d, and 6e. The metal plate 6a has the shape of an inverted L in section. The sealing member 6 is mounted in the seal groove 3b of the outer ring 3 by press fitting. The rubber molding 6b is in close contact with an outer surface of the metal plate 6a. The rubber molding 6b is a vulcanizable fluororubber composition which comprises a copolymer containing tetrafluoroethylene; propylene; and a crosslinkable monomer which is unsaturated hydrocarbon having two to four carbon atoms, in which a part of hydrogen atoms is substituted with fluorine atoms. The rubber molding 6b is bifurcated in section. The main lip portion 6e forming one of the bifurcation extends obliquely downward toward the left, whereas the auxiliary lip portion 6d forming the other of the bifurcation extends obliquely downward toward the right. At a middle position of the metal plate 6a, the cylindrical third lip portion 6c is formed by extending it leftward in FIG. 5 from the rubber molding 6b.

The flinger 22 made of stainless steel is disposed on the rotation shaft 10. The flinger 22 is constructed of a small cylinder 22c which fits on the rotation shaft 10, a large cylinder 22a coaxially enclosing the small cylinder 22c, and a flange portion 22b radially connecting both cylinders to each other. The third lip portion 6c of the rubber molding 6b is in sliding contact with the periphery of the large cylinder 22a of the flinger 22. The main lip portion 6e is in sliding contact with the periphery of the small cylinder 22c. The auxiliary lip portion 6d is in sliding contact with the periphery of the rotation shaft 10. The third lip portion 6c, the main lip portion 6e, and the auxiliary lip portion 6d form a seal respectively.

When vapor and droplets of cooling water scatter to the seal unit 23 from the outside, a peripheral surface of the flinger 22 receives them to prevent the cooling water from directly contacting the sealing member 6. Thereby it is possible to decrease the degree of deformation and expansion of the sealing member 6 and particularly the third lip portion 6c. The grease composition and the like enclosed inside the bearing 1 is sealed with the auxiliary lip portion 6d of the sealing member 6 and the main lip portion 6e thereof and thereby can be prevented from leaking to the outside.

An urea-based grease containing an urea compound is enclosed in the above-exemplified rolling bearing.

It is possible to mix mineral oils such as paraffin mineral oil and naphthenic mineral oil; synthetic hydrocarbon oils such as poly-α-olefin (hereinafter referred to as PAO); ether oils such as dialkyldiphenyl ether oil, alkyltriphenyl ether oil, and alkyltetraphenyl ether oil; and ester oils such as diester oil, polyol ester oil, complex ester oils of these oils, aromatic ester oil, and carbonate oil; with base oil of the urea-based grease either alone or in combination.

In consideration of lubricating performance and lubricating life of these oils at high temperatures and speeds, the alkyldiphenyl ether oil, the ester oils, the PAO oil, and the like are preferable.

The urea compound to be contained in the urea-based grease as a thickener thereof contains a urea bond (—NHCONH—). As the urea compound, diurea, triurea, tetraurea, urea urethane, and the like are listed. The diurea having two urea bonds in its molecule is preferable as the urea compound and is shown by the following chemical formula 1.

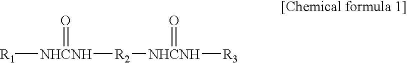

Reference symbols R₁ and R₃ in the chemical formula 1 denote a monovalent aliphatic group, alicyclic group or aromatic group. The urea-based grease containing aliphatic diurea having aliphatic groups R₁ and R₃ as a thickener is preferable because it mixes with the fluorine grease readily when the urea-based grease is mixed with the fluorine grease.

Reference symbol R₂ denotes a bivalent aromatic hydrocarbon group having 6 to 15 carbon atoms and shown by the following chemical formula 2.

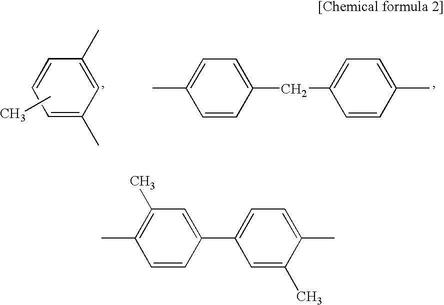

As an example of the method of producing the urea compound, a diisocyanate compound is reacted with an amine compound whose equivalent weight is equal to that of the diisocyanate compound.

It is preferable that the urea-based grease contains 95 to 70 wt % of the base oil and 5 to 30 wt % of the urea compound for the total amount of the grease. By setting the mixing ratio to this range, the grease enclosed in the bearing leaks little therefrom. Thereby the consistency of the urea-based grease can be so adjusted that it keeps a favorable lubricity for a long time.

In a strict operating temperature condition, it is possible to use a mixture of the above-described grease containing the urea compound as its thickener and the fluorine grease.

A preferable example of the fluorine grease contains polytetrafluoroethylene (hereinafter referred to as PTFE) as its thickener and perfluoro polyether (hereinafter referred to as PFPE) as its base oil.

It is preferable that the fluorine grease contains 50 to 90 wt % of PFPE and 50 to 10 wt % of fluororesin powder for the total amount of the fluorine grease. By setting the mixing ratio to this range, the fluorine grease to be enclosed in the bearing leaks little therefrom. Thereby the consistency of the fluorine grease can be so adjusted that it keeps a low torque for a long time.

It is preferable that the mixing ratio (weight ratio) between the urea-based grease of the mixed grease and the fluorine grease thereof is 30:70 to 75:25. When the urea-based grease is mixed with the fluorine grease, it is the most preferable that the urea-based grease contains the aliphatic diurea as its thickener and the ester oil as its base oil, and that the fluorine grease contains PTFE as its thickener and PFPE as its base oil.

### EXAMPLES

### Mixing Examples 1 through 3 and Comparative Mixing Examples 1 through 6

Rubber compositions of examples and comparative examples are respectively shown below.

By kneading the components mixed with each other at mixing ratios shown in table 1 by using an open roll whose temperature was set to 50° C., unvulcanized rubber compositions were obtained. The materials shown in table 1 are described below:

(1) Fluororubber 1: produced by DuPont Dow Elastomer Inc.; “VTR8802” (vulcanizing agent was added)

(2) Fluororubber 2: produced by Asahi Glass Co., Ltd.; “Aflas 150”

(3) Fluororubber 3: produced by DuPont Dow Elastomer Inc.; “A32J”

(4) Acrylic rubber: produced by Zeon Corporation; “AR71”

(5) Magnesium oxide: produced by Kyowa Chemical Industry Co., Ltd.; “Kyowamag 150”

(6) Calcium hydroxide: produced by Ohmi Chemical Industry Co., Ltd.; “Calbit”

(7) Carbon 1: produced by Engineered Carbons Inc.; “N990”

(8) Co-crosslinking agent: produced by Nippon Kasei Chemical Co., Ltd.; Triallyl isocyanurate (TAIC)

(9) Vulcanizing agent: produced by Kayaku Akzo Corporation: “Perkadox 14”

(10) Carbon 2: produced by Tokai Carbon Co., Ltd.; “SEAST 3”

(11) Sulfur: produced by Tsurumi Chemical Industry Co., Ltd.; “Salfax PMC”

(12) Age resistor: Ouchi Shinko Chemical Industrial Co., Ltd.; “Nocrac CD”

(13) Sodium stearate: produced by Kao Corporation; “Nsoap”

(14) Potassium stearate: produced by NOF CORPORATION; “Nonsaru SK-1”

The fluororubber 1 is a vulcanizable fluororubber which comprises a copolymer containing tetrafluoroethylene; propylene; and a crosslinkable monomer which is an unsaturated hydrocarbon having two to four carbon atoms, in which a part of hydrogen atoms is substituted with fluorine atoms. The fluororubber 2 consists of tetrafluoroethylene-propylene rubber. The fluororubber 3 consists of vinylidene fluoride.

TABLE 1

| | Mixing example | | | Comparative mixing example | | | | | |
|---|---|---|---|---|---|---|---|---|---|
| | 1 | 2 | 3 | 1 | 2 | 3 | 4 | 5 | 6 |
| Specimen | A-1 | A-2 | A-3 | C-1 | C-2 | C-3 | C-4 | C-5 | C-6 |

Component (part by weight)

| | | | | | | | | | |
|---|---|---|---|---|---|---|---|---|---|
| Fluororubber (1) | 100 | 100 | 100 | — | — | — | — | — | — |
| Fluororubber (2) | — | — | — | — | 100 | — | 100 | — | — |
| Fluororubber (3) | — | — | — | 100 | — | 100 | — | 100 | — |
| Acrylic rubber | — | — | — | — | — | — | — | — | 100 |
| Magnesium oxide | 8 | 8 | 8 | 3 | — | 3 | — | 3 | — |
| Calcium hydroxide | — | — | — | 6 | — | 6 | — | 6 | — |
| Carbon 1 | 30 | 30 | 28 | 20 | 35 | 20 | 35 | 20 | — |
| Co-crosslinking agent | — | — | — | — | 5 | — | 5 | — | — |
| Vulcanizing agent | — | — | — | — | 1 | — | 1 | — | — |
| Carbon 2 | — | — | 0.5 | — | — | — | — | — | 50 |
| Stearic acid | — | — | — | — | — | — | — | — | 1 |
| Age resistor | — | — | — | — | — | — | — | — | 2 |
| Sulfur | — | — | — | — | — | — | — | — | 0.3 |
| Sodium stearate | — | — | — | — | — | — | — | — | 3 |
| Potassium stearate | — | — | — | — | — | — | — | — | 0.5 |

By using the above-described unvulcanized rubber compositions, vulcanized moldings were obtained by using a vulcanizing press machine. By setting the temperature of a die to 170° C., each of the above-described unvulcanized rubber composition was vulcanized for 12 minutes at 170° C. in a primary vulcanization. Thereafter a secondary vulcanization was performed in a constant-temperature bath. The secondary vulcanizing condition was set to 200° C. and 24 hours in the mixing examples 1 and 2 and the comparative mixing examples 1 through 3; 200° C. and 24 hours in the mixing example 3 and the comparative mixing examples 4 and 5; and 170° C. and 4 hours in the comparative mixing example 6.

Specimens were formed by punching obtained vulcanized moldings into the configuration of the specimen specified in JIS K 6251, No. 3. The obtained specimens were denoted as (A-1) through (A-3) and (C-1) through (C-6).

### Examples 1 and 2 and Comparative Examples 1 and 3

The specimens were immersed in 30% water solution of sodium hydroxide and a solution obtained by diluting a water-soluble cutting lubricant (produced by Yushiro Chemical Industry Co., Ltd.; Yushiro-ken FGS798K) containing 15 to 25% of triethanolamine with pure water 30 times respectively under conditions of the temperature and immersion period of time shown in table 2 to measure values indicating the properties of the specimens before and after the immersion. The hardness, tensile strength, tensile elongation, and volume were measured to evaluate the change in the hardness, the change rate of the tensile strength, the change rate of the tensile elongation, and the change rate of the volume, relative to the hardness, the tensile strength, the tensile elongation, and the volume of the specimens before the immersion. The measuring conditions were set in conformity to JIS K 6253 in the hardness, JIS K 6251 in the tensile strength and the tensile elongation, and JIS K 6258 in the volume before and after the immersion. Table 2 shows the results. The mark of * in table 2 shows “unmeasurable”.

TABLE 2

| | | | Comparative | |
|---|---|---|---|---|
| | Example | | example | |
| | 1 | 2 | 1 | 3 |
| Specimen | A-1 | A-2 | C-1 | C-3 |
| Dipping solution | Water solution | Water-soluble | Water solution | Water-soluble |
| | of sodium | cutting lubricant | of sodium | cutting lubricant |
| | hydroxide | containing | hydroxide | containing |
| | | triethanolamine | | triethanolamine |
| Properties in ordinary state | | | | |
| Hardness (durometer A) | A79 | A79 | A72 | A72 |
| Tensile strength [Mpa] | 15.1 | 15.1 | 18.8 | 16.5 |
| Tensile elongation [%] | 250 | 250 | 290 | 290 |
| 80° C. × 168 hours | | | | |
| Change of hardness [ [symbol] Points] | +1 | −1 | −17 | −9 |
| Change rate of tensile strength [%] | +4 | +2 | −39 | −18 |
| Change rate of tensile elongation [%] | +3 | +8 | +12 | −5 |
| Change rate of volume [%] | +0.1 | +10 | * | +24 |
| 80° C. × 500 hours | | | | |
| Change of hardness [ [symbol] Points] | +1 | | −38 | |
| Change rate of tensile strength [%] | +2 | | * | |
| Change rate of tensile elongation [%] | +3 | | * | |
| Change rate of volume [%] | +1.1 | | * | |
| 80° C. × 1000 hours | | | | |
| Change of hardness [ [symbol] Points] | +3 | | −38 | |
| Change rate of tensile strength [%] | +2 | | * | |
| Change rate of tensile elongation [%] | −7 | | * | |
| Change rate of volume [%] | +1.8 | | * | |

The specimens of the examples 1 and 2 deteriorated insignificantly even in the long-time immersion and had an excellent resistance respectively to the alkali solution and to the cutting lubricant.

The specimen of the comparative example 1 deteriorated significantly when it was immersed in the alkali solution. The specimen of the comparative example 1 deteriorated significantly in properties when it was immersed in the alkali solution for the long time, compared with the deterioration when immersed therein for the short time. When the specimen of the comparative example 3 was immersed in the cutting lubricant, the decrease in the hardness and mechanical strength thereof and the expansion of the volume thereof were significant.

### Examples 3 though 7 and Comparative Examples 4 through 12

Urea-based grease and mixed grease that can be enclosed in the rolling bearing of the present invention are shown below:

(1) Urea-Based Grease 1

Produced by Kluber Inc.: Asonic HQ72-102 (thickener: aliphatic diurea, base oil: aromatic polyester oil, kinematic viscosity at 40° C.: 100 mm²/second)

(2) Urea-Based Grease 2

Base oil composed of mixed oil of PAO oil (produced by Nippon Steel Chemical Co., Ltd., commercial name: Shin-fluid 601) and alkyldiphenyl ether oil (produced by Matsumura Oil Research Corp., commercial name: LB100) was prepared at a mixing ratio of 20:80 wt %. The base oil was divided into two solutions. 4,4′-diphenylmethane diisocyanate was dissolved in one of the two solutions. P-toluidine whose equivalent weight was equal to that of the 4,4′-diphenylmethane diisocyanate was dissolved in the other of the two solutions. The 4,4′-diphenylmethane diisocyanate was dissolved in the base oil so that the aromatic diurea compound was 20 wt % of the total amount of grease to be obtained. The solution in which the p-toluidine was dissolved was added to the solution in which the 4,4′-diphenylmethane diisocyanate was dissolved, while the latter solution was being stirred. The stirring was continued for reaction at 100 to 120° C. for 30 minutes to deposit the aromatic diurea compound in the base oil. One part by weight of sorbitan triolate, one part by weight of sodium sebacate, and two parts by weight of alkyldiphenylamine which is an antioxidant were added thereto for the total amount, namely, 100 parts by weight of the grease to be obtained. The mixture was stirred at 100 to 120° C. for 10 minutes. Thereafter the mixture was cooled and homogenized by a three-roll to obtain the grease.

(3) Mixed Grease

For the entire grease, 33 wt % of fluororesin powder (produced by DuPont Inc., commercial name: Bidax) was added to 67 wt % of perfluoro polyether oil (produced by DuPont Inc., commercial name: Krytox 143AC). Thereafter the mixture was stirred and fed to a roll mill. Thereby semisolid fluorine grease “containing PTFE powder as its thickener and PFPE as its base oil” was obtained.

Thereafter one mole of diisocyanate for the total amount of the grease was dissolved in a half amount of 88 wt % of aromatic ester oil (produced by ADEKA Corporation, commercial name: Prover T90). Two moles of monoamine were dissolved in the remaining half amount of the aromatic ester oil. Thereafter the solution of the aromatic ester oil in which the monoamine was dissolved was added to the half amount of the base oil in which the diisocyanate was dissolved, while being stirred. The stirring was continued for reaction at 100 to 120° C. for 30 minutes. As a result, 12 wt % of a urea compound (aliphatic diurea in which R₁ and R₃ in the above-described chemical formula 1 denote aliphatic group, and R₂ denotes diphenylmethane group) was deposited in the base oil. Thereafter the urea compound was supplied to a roll mill. Thereby semisolid urea-based grease “containing the urea compound as its thickener and synthetic oil as its base oil” was obtained.

40 wt % of the above-described fluorine grease, 59 wt % of the above-described urea-based grease, and 1 wt % of an amine rust-preventive agent containing mineral oil as its base were mixed with one another and stirred to obtain mixed grease of the fluorine grease and the urea-based grease.

The specimens were immersed completely in the urea-based grease 1, the urea-based grease 2, and the mixed grease in the condition of (170° C. or 200° C.)×1000 hours to measure values indicating the properties of the specimens before and after the immersion. The hardness, tensile strength, tensile elongation, and volume of each specimen were measured to evaluate the change in the hardness, the rate of change in the tensile strength, the rate of change in the tensile elongation, and the rate of change in the volume relative to the hardness, the tensile strength, the tensile elongation, and the volume of the specimens before the immersion. The measuring conditions were set in conformity to JIS K 6253 in the hardness, JIS K 6251 in the tensile strength and the tensile elongation, and JIS K 6258 in the volume before and after the immersion. The results are shown in tables 3 and 4. The mark of * in tables 3 and 4 shows “unmeasurable.”

TABLE 3

| | Example | | | | |
|---|---|---|---|---|---|
| | 3 | 4 | 5 | 6 | 7 |
| Specimen | A-3 | A-3 | A-3 | A-3 | A-3 |
| | Urea-based | Mixed | Urea-based | Mixed | Urea-based |
| Dipping solution | grease 1 | grease | grease 1 | grease | grease 2 |
| Properties in ordinary state | | | | | |
| Hardness (durometer A) | A79 | A79 | A79 | A79 | A79 |
| Tensile strength [Mps] | 15.1 | 15.1 | 15.1 | 15.1 | 15.1 |
| Tensile elongation [%] | 250 | 250 | 250 | 250 | 250 |
| 200° C. × 72 hours | | | | | |
| Change of hardness [ [symbol] Points] | −11 | −5 | | | |
| Change rate of tensile strength [%] | −4.4 | −8.9 | | | |
| Change rate of tensile elongation [%] | +12.6 | +12.6 | | | |
| Change rate of volume [%] | +7.9 | +10.1 | | | |
| 200° C. × 168 hours | | | | | |
| Change of hardness [ [symbol] Points] | −11 | −8 | | | |
| Change rate of tensile strength [%] | +6.7 | −25.9 | | | |
| Change rate of tensile elongation [%] | +13.7 | −14.8 | | | |
| Change rate of volume [%] | +12.7 | +12.0 | | | |
| 200° C. × 504 hours | | | | | |
| Change of hardness [ [symbol] Points] | −14 | −8 | | | |
| Change rate of tensile strength [%] | −27.0 | −14.5 | | | |
| Change rate of tensile elongation [%] | +1.2 | −5.3 | | | |
| Change rate of volume [%] | +17.2 | +13.8 | | | |
| 200° C. × 1000 hours | | | | | |
| Change or hardness [ [symbol] Points] | −20 | −3 | | | |
| Change rate of tensile strength [%] | −42.0 | −15.4 | | | |
| Change rate of tensile elongation [%] | −48.7 | −16.1 | | | |
| Change rate of volume [%] | +20.6 | +20.2 | | | |
| 170° C. × 72 hours | | | | | |
| Change of hardness [ [symbol] Points] | | | −6 | −4 | −4 |
| Change rate of tensile strength [%] | | | −5.9 | −5.3 | −12.2 |
| Change rate of tensile elongation [%] | | | +10.3 | +7.2 | −7.4 |
| Change rate of volume [%] | | | +4.0 | +3.2 | +3.6 |
| 170° C. × 144 hours | | | | | |
| Change of hardness [ [symbol] Points] | | | | | −4 |
| Change rate of tensile strength [%] | | | | | −2.2 |
| Change rate of tensile elongation [%] | | | | | −7.5 |
| Change rate of volume [%] | | | | | +3.4 |
| 170° C. × 168 hours | | | | | |
| Change of hardness [ [symbol] Points] | | | −6 | −5 | −2 |
| Change rate of tensile strength [%] | | | −6.2 | −18.3 | −1.1 |
| Change rate of tensile elongation [%] | | | +7.0 | +1.1 | −3.7 |
| Change rate of volume [%] | | | +5.5 | +4.0 | +3.4 |
| 170° C. × 504 hours | | | | | |
| Change of hardness [ [symbol] Points] | | | −5 | −5 | 0 |
| Change rate of tensile strength [%] | | | −13.0 | −9.2 | −32.7 |
| Change rate of tensile elongation [%] | | | −25.0 | −4.1 | −10.2 |
| Change rate of volume [%] | | | +7.9 | +6.4 | +3.7 |
| 170° C. × 1000 hours | | | | | |
| Change of hardness [ [symbol] Points] | | | −8 | −6 | +2 |
| Change rate of tensile strength [%] | | | −13.7 | −12.1 | +0.8 |
| Change rate of tensile elongation [%] | | | +9.3 | −7.2 | −44.4 |
| Change rate of volume [%] | | | +9.2 | +8.8 | +3.7 |

TABLE 4

| | Comparative example | | | | | | | | |
|---|---|---|---|---|---|---|---|---|---|
| | 5 | 6 | 7 | 8 | 9 | 10 | 11 | 12 | 13 |
| Specimen | C-4 | C-5 | C-6 | C-4 | C-4 | C-5 | C-6 | C-4 | C-5 |
| | | | | | Urea- | Urea- | Urea- | Urea- | Urea- |
| | Mixed | Mixed | Mixed | Mixed | based | based | based | based | based |
| Dipping solution | grease | grease | grease | grease | grease 1 | grease 1 | grease 1 | grease 1 | grease 2 |
| Properties in ordinary state | | | | | | | | | |
| Hardness (durometer A) | A76 | A72 | A70 | A76 | A76 | A72 | A70 | A76 | A72 |
| Tensile strength [Mpa] | 18.1 | 16.5 | 15.2 | 18.1 | 18.1 | 16.5 | 15.2 | 18.1 | 16.5 |
| Tensile elosgerion [%] | 300 | 290 | 270 | 300 | 300 | 290 | 270 | 300 | 290 |
| 200° C. × 72 hours | | | | | | | | | |
| Change of hardness [ [symbol] Points] | | | | −11 | | | | −14 | |
| Change rate of tensile strength [%] | | | | −21.8 | | | | −19.8 | |
| Change rate of tensile elongation [%] | | | | −26.7 | | | | −4.4 | |
| Change rate of volume [%] | | | | +14.0 | | | | +14.7 | |
| 200° C. × 168 hours | | | | | | | | | |
| Change of hardness [ [symbol] Points] | | | | −13 | | | | −14 | |
| Change rate of tensile strength [%] | | | | −34.3 | | | | −21.9 | |
| Change rate of tensile elongation [%] | | | | −15.3 | | | | −3.3 | |
| Change rate ef voiwne [%] | | | | +22.8 | | | | +19.8 | |
| 200° C. × 504 hours | | | | | | | | | |
| Change of hardness [ [symbol] Points] | | | | −15 | | | | −19 | |
| Change rate of tensile strength [%] | | | | −33.1 | | | | −65.2 | |
| Change rate of tensile elongation [%] | | | | −16.1 | | | | −18.7 | |
| Change rate of volume [%] | | | | +25.8 | | | | +21.6 | |
| 200° C. × 1000 hours | | | | | | | | | |
| Change of hardness [ [symbol] Points] | | | | −17 | | | | −32 | |
| Change rate of tensile strength [%] | | | | −39.2 | | | | −75.9 | |
| Change rate of tensile elongation [%] | | | | −17.2 | | | | −75.0 | |
| Change rate of volume [%] | | | | +28.3 | | | | +40.0 | |
| 170° C. × 72 hours | | | | | | | | | |
| Change of hardness [ [symbol] Points] | −10 | +15 | −24 | | −8 | +17 | −29 | | −2 |
| Change rate of tensile strength [%] | −16.7 | −798 | −32.6 | | −17.9 | −82.9 | −42.6 | | −37.2 |
| Change rate of tensile elongation [%] | +8.1 | −76.9 | +156.9 | | +1.4 | −100 | +176.9 | | −35.7 |
| Change rate of volume [%] | +7.8 | +10.5 | +25.2 | | +7.6 | +9.7 | +32.2 | | +4.2 |
| 170° C. × 144 hours | | | | | | | | | |
| Change of hardness [ [symbol] Points] | | | | | | | | | −1 |
| Change rate of tensile strength [%] | | | | | | | | | −46.3 |
| Change rate of tenaile elongation [%] | | | | | | | | | −46.4 |
| Change rate ef volume [%] | | | | | | | | | +3.5 |
| 170° C. × 168 hours | | | | | | | | | |
| Change of hardness [ [symbol] Ponits] | −11 | * | * | −8 | * | * | | | −5 |
| Change rate of tensile strength [%] | −33.2 | −98.3 | * | −11.6 | * | * | | | −55.9 |
| Change rate of tensile elongation [%] | +11.6 | −100.0 | * | +7.2 | * | * | | | −57.1 |
| Change rate of volume [%] | +12.5 | +13.5 | * | +8.7 | * | * | | | +3.6 |
| 170° C. × 504 hours | | | | | | | | | |
| Change of hardness [ [symbol] Points] | −13 | * | * | −8 | * | * | | | * |
| Change rate of tensile strength [%] | −27.5 | * | * | −30.8 | * | * | | | −70.4 |
| Change rate of tensile elongation [%] | −7.5 | * | * | +17.4 | * | * | | | −100 |
| Change rate of volume [%] | +18.3 | * | * | +8.5 | * | * | | | +8.9 |
| 170° C. × 1000 hours | | | | | | | | | |
| Change of hardness [ [symbol] Points] | −15 | * | * | −11 | * | * | | | * |
| Change rate ef tensile strength [%] | −34.2 | * | * | −45.9 | * | * | | | −44.5 |
| Change rate of tensile elongation [%] | −9.5 | * | * | +20.2 | * | * | | | −100 |
| Change rate of volume [%] | +20.1 | * | * | +11.6 | * | * | | | +10.0 |

The specimens of the examples 3 through 7 deteriorated insignificantly in the long-time immersion at the high temperature and had an excellent resistance respectively to the urea-based grease and the mixed grease.

### Example 8

The unvulcanized rubber composition composing the specimen (A-3) was molded into a core made of iron to obtain a sealing member (6 of FIG. 5) for use in a bearing 6204 (inner diameter: 20 mm, outer diameter: 47 mm, width: 14 mm). The sealing member was incorporated in a bearing well cleaned with petroleum benzine, and the mixed grease occupying 38% of the volume of the entire space was enclosed inside the bearing to formate strolling bearing. The obtained rolling bearing was evaluated in a durability test 1 at high temperature. Results are shown in table 5.

Durability Test 1 at High Temperature

In the durability test 1 at high temperature, the rolling bearing was rotated at a radial load of 67N, a thrust load of 67N, 10000 rpm, and an atmospheric temperature of 220° C. The period of time required for the motor to stop owing to an overload was measured. The test period of time was 1000 hours at maximum.

### Example 9

The same sealing member as that of the example 8 was incorporated in a bearing well cleaned with petroleum benzine, and the urea-based grease 2 occupying 38% of the volume of the entire space was enclosed inside the bearing to form a test rolling bearing. The obtained rolling bearing was evaluated in a durability test 2 at high temperature. Results are shown in table 5.

Durability Test 2 at High Temperature

In the durability test 2 at high temperature, the rolling bearing was rotated at a radial load of 67N, a thrust load of 67N, 10000 rpm, and an atmospheric temperature of 180° C. The period of time required for the motor to stop owing to an overload was measured. The test period of time was 500 hours at maximum.

### Comparative Examples 14 and 15

By using the specimens (C-4) and (C-5), a test rolling bearing of each of the comparative examples 14 and 15 was formed in a manner similar to that of the example 8. A durability test 1 at high temperature was conducted in a manner similar to that of the example 8. Results are shown in table 5.

### Comparative Examples 16 and 17

By using the specimens (C-5) and (C-6), a test rolling bearing of each of the comparative examples 16 and 17 was formed in a manner similar to that of the example 9. The durability test 2 at high temperature was conducted in a manner similar to that of the example 9. Results are shown in table 5.

TABLE 5

| | Example | | Comparative example | | | |
|---|---|---|---|---|---|---|
| | 8 | 9 | 14 | 15 | 16 | 17 |
| Specimen | A-3 | A-3 | C-4 | C-5 | C-5 | C-6 |
| Material | | | | | | |
| Durability test 1 | 1000 | — | 570 | 340 | — | — |
| at high temperature | or more | | | | | |
| (Life (hour)) | | | | | | |
| Durability test 2 | — | 500 | — | — | 320 | 150 |
| at high temperature | | or more | | | | |
| (Life (hour)) | | | | | | |

The rolling bearings of the examples 8 and 9 allowed the motor to operate for not less than 500 hours. After the test finished, cracks were not found in visual observation.

The rolling bearings of the comparative examples 14 and 15 had seizing in a shorter period of time than the period of time in which the rolling bearing of the example 8 had seizing. The rolling bearings of the comparative examples 16 and 17 had seizing in a shorter period of time than the period of time in which the rolling bearing of the example 9 had seizing. It is considered that the leak of the grease which occurred during the operation mainly caused the rolling bearings to have the short lives. In the rolling bearings of the comparative examples 15 and 17, a large number of cracks were found at the contact portion of the seal after the test finished.

### Example 10 and Comparative Examples 2 and 18

As shown in table 6, the specimens (A-1), (C-2), and (C-5) were immersed in 30% water solution of Toyota Genuine Long Life Coolant (base: ethylene glycol) under conditions of the temperature and immersion period of time shown in table 6 to measure values indicating the properties of the specimens before and after the immersion. The hardness, tensile strength, tensile elongation, and volume were measured to evaluate the change in the hardness, the change rate of the tensile strength, the change rate of the tensile elongation, and the change rate of the volume, relative to the hardness, the tensile strength, the tensile elongation, and the volume of the specimens before the immersion. The measuring conditions were set in conformity to JIS K 6253 in the hardness, JIS K 6251 in the tensile strength and the tensile elongation, and JIS K 6258 in the volume before and after the immersion. Table 6 shows the results.

TABLE 6

| | | Comparative | |
|---|---|---|---|
| | Example | example | |
| | 10 | 2 | 18 |
| Specimen | A-1 | C-2 | C-5 |
| Properties in ordinary state | | | |
| Hardness (durometer A) | A79 | A76 | A72 |
| Tensile strength [Mpa] | 15.1 | 18.1 | 16.5 |
| Tensile elongation [%] | 250 | 300 | 290 |
| 80° C. × 168 hours | | | |
| Change of hardness [ [symbol] Points] | −1 | −1 | −2 |
| Change rate of tensile strength [%] | +12 | +10 | +2 |
| Change rate of tensile elongation [%] | +1 | −2 | 0 |
| Change rate of volume [%] | +8 | +7 | +8 |
| 80° C. × 500 hours | | | |
| Change of hardness [ [symbol] Points] | −1 | −5 | −7 |
| Change rate of tensile strength [%] | +5 | −1 | −5 |
| Change rate of tensile elongation [%] | 0 | 0 | −5 |
| Change rate of volume [%] | +9 | +8 | +9 |
| 80° C. × 1000 hours | | | |
| Change of hardness [ [symbol] Points] | −1 | −7 | −6 |
| Change rate of tensile strength [%] | −1 | −20 | −8 |
| Change rate of tensile elongation [%] | 0 | −17 | −8 |
| Change rate of volume [%] | +9 | +9 | +9 |

The specimen of the example 10 deteriorated insignificantly even in the long-time immersion and had an excellent resistance to the water solution of the long life coolant.

The specimens of the comparative examples 2 and 18 deteriorated significantly when they were immersed in the water solution of the long life coolant. Especially, the specimen of the comparative example 2 deteriorated significantly in properties when it was immersed in the water solution of the long life coolant for the long time though it little deteriorated when immersed therein for the short time.

### INDUSTRIAL APPLICABILITY

The rolling bearing of the present invention is alkali-resistant, resistant to cooling-water, and is highly resistant to grease. Therefore in manufacturing equipment such as a machine-manufacturing factory, a plant for producing macromolecular materials, a plant for manufacturing liquid crystal films, and the like, the rolling bearing can be preferably utilized when it is used for a machine tool and a liquid-feeding pump which contact a cutting/grinding lubricant and an alkali solution, when it is used for a circulation pump for cooling water containing a long-life coolant, when it is used for a fuel cell system which is used at a high-speed and temperature, and especially when it is used for a compressed fluid-feeding machine for feeding various fluids.

### BRIEF DESCRIPTION OF THE DRAWINGS

FIG. 1 is a sectional view of a rolling bearing of the present invention.

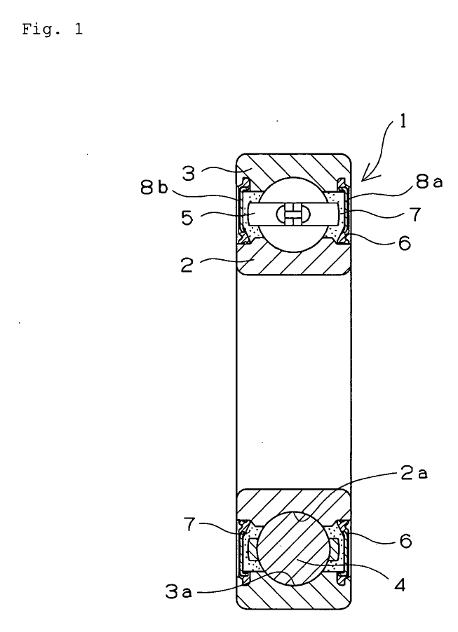

FIG. 2 is a sectional view of a sealing member of the rolling bearing of the present invention.

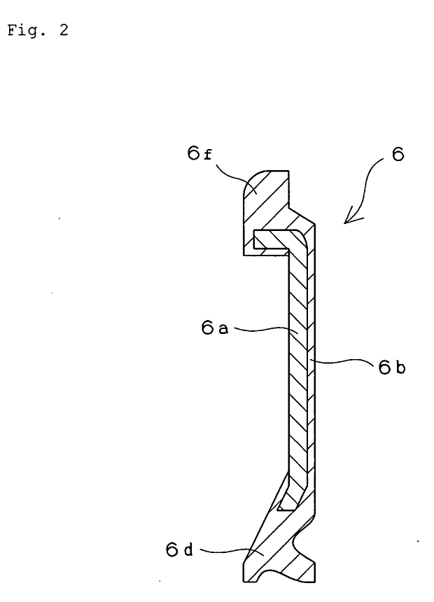

FIG. 3 is a sectional view showing an example of an impeller-type compressed fluid-feeding machine.

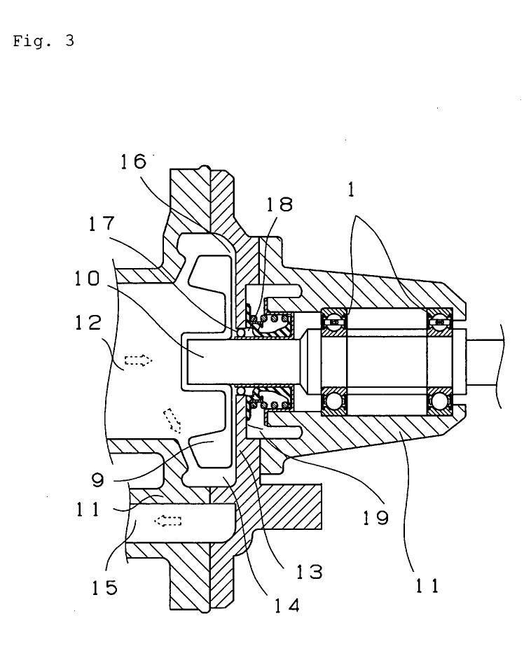

FIG. 4 is a sectional view of the impeller-type compressed fluid-feeding machine of a rolling bearing for use in a cooling-water pump.

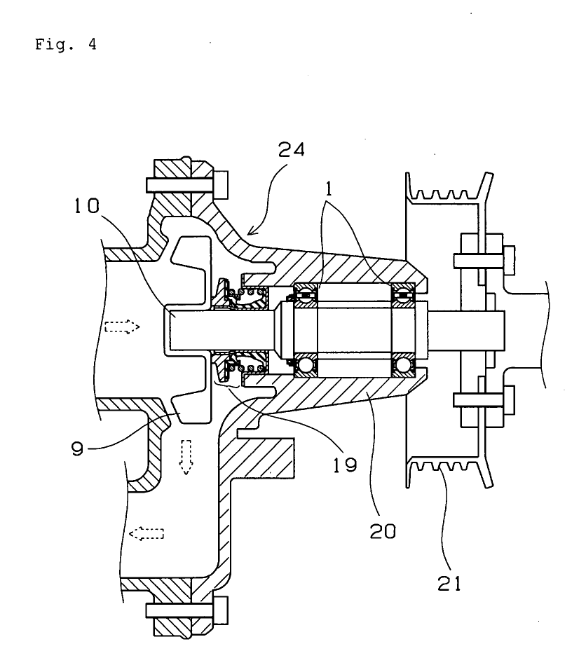

FIG. 5 is a sectional view of a seal unit of the rolling bearing of the present invention for use in the cooling-water pump.

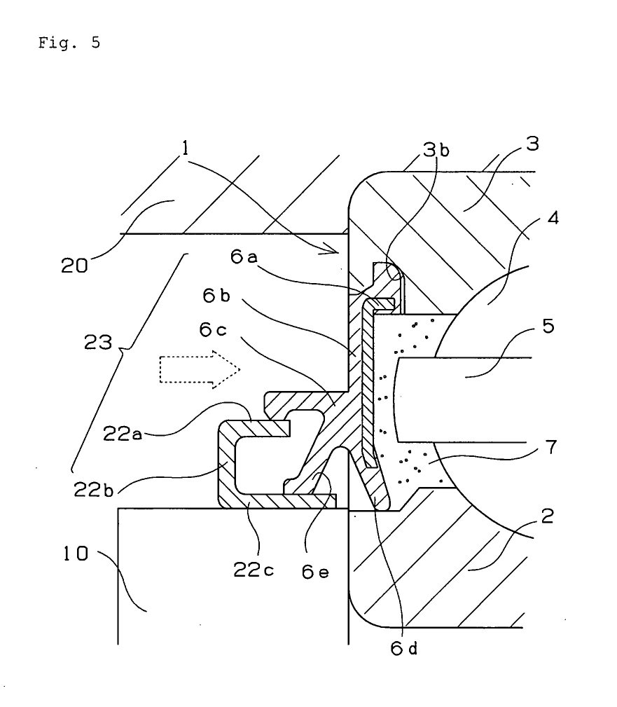

FIG. 6 is a perspective view of the cooling-water pump.

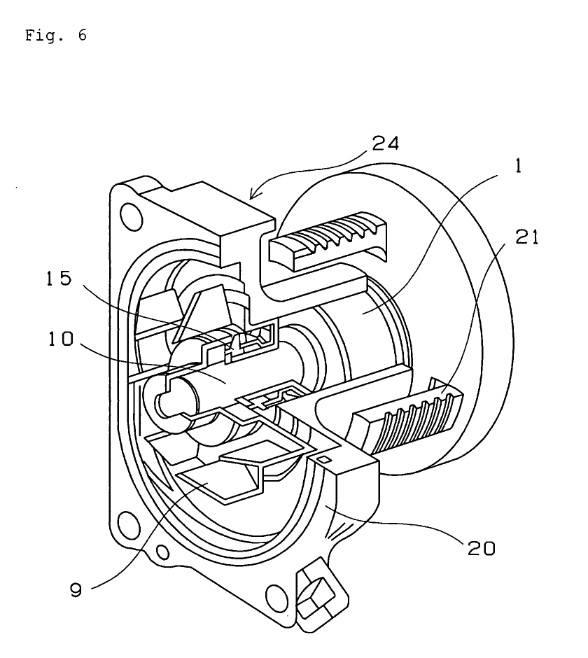

### EXPLANATION OF REFERENCE SYMBOLS AND NUMERALS

1: rolling bearing
2: inner ring
3: outer ring
4: rolling element
5: cage
6: sealing member
7: grease
8: open portion
9: impeller
10: rotation shaft
11: casing
12: gas-sucking port
13: back plate
14: pressure volute
15: gas-discharging port
16: rear space
17: seal ring
18: gap
19: mechanical seal
20: housing
21: pulley
22: flinger
23: seal unit
24: cooling-water pump

1. A rolling bearing comprising an inner ring; an outer ring; a plurality of rolling elements interposed between said inner ring and said outer ring; and a sealing member provided at an open portion which is disposed at both axial ends of said inner ring and said outer ring,
wherein said sealing member comprises a rubber molding; and
said rubber molding is made of a vulcanizable fluororubber composition which comprises a copolymer containing tetrafluoroethylene; propylene; and a crosslinkable monomer which is an unsaturated hydrocarbon having two to four carbon atoms, in which a part of hydrogen atoms is substituted with fluorine atoms.

2. The rolling bearing according to claim 1, wherein said crosslinkable monomer is at least one monomer selected from among trifluoroethylene; 3,3,3-trifluoropropene-1; 1,2,3,3,3-pentafluoropropene; 1,1,3,3,3-pentafluoropropylene; and 2,3,3,3-tetrafluoropropene.

3. The rolling bearing according to claim 1, wherein said copolymer contains vinylidene fluoride.

4. The rolling bearing according to claim 1, wherein a rubber hardness of said molding is 60° to 90°.

5. The rolling bearing according to claim 1, which is a rolling bearing for an alkali environment used under an alkali atmosphere.

6. The rolling bearing according to claim 5, wherein said inner ring of said rolling bearing, said outer ring thereof, and said rolling elements thereof are made of corrosion-resistant steel or ceramic.

7. The rolling bearing according to claim 1, which is used for a machine tool for cutting or grinding a material to be processed, with a cutting lubricant or a grinding lubricant interposed therebetween.

8. The rolling bearing according to claim 7, wherein said rolling bearing used for said machine tool is a main spindle bearing or a ball screw support bearing.

9. The rolling bearing according to claim 1, which is used for a cooling-water pump, wherein a rotation shaft is supported by said inner ring, with one end of said rotation shaft connected to a pulley driven by an engine and other end of said rotation shaft connected to an impeller for circulating cooling water; said outer ring is fixed to a housing; a plurality of rolling elements is interposed between said inner ring and said outer ring; a space between said rotation shaft and the outer ring is sealed by a pair of sealing members, having a rubber molding respectively, which is fixed to both ends of said outer ring; and said molding of said fluororubber composition according to claim 1 is used for a rubber molding of said sealing member disposed at least at a side of said impeller.

10. The rolling bearing according to claim 1, which is used for a fuel cell system to rotatably support a rotational portion provided on a compressed fluid-feeding machine for feeding a fluid which is used in said fuel cell system.

11. The rolling bearing according to claim 1, wherein a grease to be enclosed in said rolling bearing contains a urea compound.

12. The rolling bearing according to claim 11, wherein said grease containing said urea compound is mixed grease of fluorine grease and urea-based grease.
